(19) United States
(12) Patent Application Publication
(10) Pub. No.: US 2004/0133633 A1
(43) Pub. Date: Jul. 8, 2004

(54) Method and apparatus for adaptive client communications

(75) Inventors: Daniel Fearnley, Stratford, CT (US); Kenneth Daniels, Essex, CT (US); Valerie Bschieder, Southbury, CT (US); Mark Ferraro, Hamden, CT (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Neopost Inc., Shelton, CT

(21) Appl. No.: 10/356,402

(22) Filed: Jan. 31, 2003

Related U.S. Application Data
(60) Provisional application No. 60/431,071, filed on Dec. 5, 2002.

(51) Int. Cl. G06F 15/16; G06F 15/177

(52) U.S. Cl. 709/203; 709/221; 709/245

(57) ABSTRACT

A method and system within which products in the field may receive both predefined services and support as well as unknown services and support is described. The system embodied according aspects of the invention includes communicating with client applications to determine what services the client may request, to proceed to interact with those service requests, and to modify, update or provide new client services without user/customer intervention. Through the use of various web service protocols, the client is able to access infrastructure web services without requiring a priori knowledge of the services. This allows the client to adapt to changes in the provisioning of services without the prerequisite of a software upgrade or other a priori knowledge of such changes.

### CROSS-REFERENCES TO RELATED APPLICATIONS

This application claims priority from and incorporates by reference in its entirety U.S. Provisional Patent Application No. 60/431,071, filed Dec. 5, 2002, entitled “Enterprise Web Solution.”

This application is related to and incorporates by reference in their entirety the following U.S. provisional patent applications:

(1) U.S. Provisional Patent Application No. 60/290,563, entitled “A Method and System for Providing Stamps by Kiosk,” filed May 11, 2001;

(2) U.S. Provisional Patent Application No. 60/216,779, entitled “System And Method Of Printing Labels,” filed Jul. 7, 2000;

(3) U.S. Provisional Patent Application No. 60/216,653, entitled “Method And System For Dispensing Postage Over The Internet, With Enhanced Postal Security Features” filed Jul. 7, 2000;

(4) U.S. Provisional Patent Application No. 60/206,207, entitled “Providing Stamps on Secure Paper Using A Communications Network” filed May 22, 2000;

(5) U.S. Provisional Patent Application No. 60/204,357, entitled “Stamps Over a Communications Network” filed May 15, 2000;

(6) U.S. Provisional Patent Application No. 60/181,299, entitled “System and Method For Stamps Over The Internet,” filed Feb. 9, 2000; and

(7) U.S. Provisional Patent Application No. 60/181,368, entitled “System and Method For Stamps Over The Internet,” filed Feb. 8, 2000.

This application is related to and incorporates by reference in their entirety the following U.S. non-provisional patent applications:

(1) U.S. Non-Provisional patent application Ser. No. 10/109,539, entitled “Techniques for Dispensing Postage Using a Communications Network,” filed Mar. 26, 2002;

(2) U.S. Non-Provisional patent application Ser. No. 09/902,480, entitled “Method and System for Providing Stamps by Kiosk,” filed Jul. 9, 2001;

(3) U.S. Non-Provisional patent application Ser. No. 09/611,375, entitled “Providing Stamps On Secure Paper Using A Communications Network,” filed Jul. 7, 2000;

(4) U.S. Non-Provisional patent application Ser. No. 09/708,883, entitled “Techniques For Dispensing Postage Using A Communication Network,” filed Nov. 7, 2000;

(5) U.S. Non-Provisional patent application Ser. No. 09/708,975, entitled “Method Of Distributing Postage Label Sheets With Security Features,” filed Nov. 7, 2000;

(6) U.S. Non-Provisional patent application Ser. No. 09/708,913, entitled “Method And Apparatus For Providing Postage Indicia Over A Data Communication Network,” filed Nov. 7, 2000;

(7) U.S. Non-Provisional patent application Ser. No. 09/708,698, entitled “System And Method For Managing Multiple Postage Functions In A Single Account,” filed Nov. 7, 2000;

(8) U.S. Non-Provisional patent application Ser. No. 09/708,792, entitled “Targeted Advertisement Using A Security Feature On A Postage Medium,” filed Nov. 7, 2000;

(9) U.S. Non-Provisional patent application Ser. No. 09/708,185, entitled “System And Method Of Printing Labels,” filed Nov. 7, 2000;

(10) U.S. Non-Provisional patent application Ser. No. 09/708,971, entitled “Providing Stamps On Secure Paper Using A Communications Network,” filed Nov. 7, 2000; and

(11) U.S. Non-Provisional patent application Ser. No. 09/358,801, entitled “Method And Apparatus For Postage Label Authentication,” filed Jul. 21, 1999.

### BACKGROUND OF THE INVENTION

The present invention is related generally to web services and in particular to the application of the web services infrastructure to provide a novel client-server service access paradigm.

The world wide web (“WWW”, or “web”) can provide web services allowing businesses to more effectively and efficiently interact with each other, and offering the general population of web users with convenient access to services heretofore unavailable. Programmatic access to a service on the web is based on the client/server model. The provisioning of services in a conventional client/server environment requires maintaining information in the service provider center about the clients that can communicate with the service provider. The client installed base may have different products and applications running on those different products. Consequently, the provider may have to keep track of different client system configurations, different client system capabilities, different client software products, different client software loads, and so on. This allows the provider to extract the proper information from the client and to provide any information to the client that may be needed.

Web services represent a step in the continuing evolution of distributed computing architectures and hold the promise of enabling different companies to interact with each other. Many e-businesses engage in joint ventures and oftentimes make short-term marketing alliances to pursue business opportunities. Web services offer businesses the hope of facilitating electronic connection to each other to perform useful tasks. The emerging paradigm of web-oriented businesses presents opportunities for adaptation with conventional client/server models to address the need to more easily manage specific configurations of products in the field in order to facilitate support services desired by those products There is also a need for capability to provide new services to a remote product, while still being able to support existing services desired or needed by the remote product.

### SUMMARY OF THE INVENTION

In accordance with the present invention, a method and system client systems in the field may receive both predefined services and support as well as unknown services and support. The invention provides for communication between client systems and server system to determine what services the client may request, proceed to interact with those service requests and modify, update or provide new client services without user/customer intervention. The invention provides for client systems to adapt to changes to a service without the need for a software upgrade or prior knowledge of said changes.

In an embodiment of the invention, a standard transport protocol for exchanging structured and type information on the world wide web can be used. The client communications to and from the system server need not have a predetermined association of message exchange patterns (MEPs) for individual services, thus obviating a need for prior knowledge of the locations and message exchange patterns for the individual services.

### BRIEF DESCRIPTION OF THE DRAWINGS

The present invention can be appreciated by the description which follows in conjunction with the following figures, wherein:

FIG. 1 shows an embodiment of a service provisioning technique in accordance with various aspects of the present invention;

FIG. 2 is a generalized block diagram showing various components in a client system according to the present invention;

FIG. 3 is an illustrative request exemplar according to an embodiment of the invention;

FIG. 3A shows an alternate embodiment of a location service;

FIG. 4 illustrates an example of invocation processing according to an embodiment of an aspect of the invention;

FIG. 5 shows an embodiment for service invocation according to an aspect of the invention;

FIG. 6 illustrates message handling for processing requests for service according to the present invention;

FIG. 7 illustrates service invocation by a server system according to an aspect of the invention;

FIG. 8 illustrates handling by a client system according to an aspect of the invention;

FIG. 9 shows sill another aspect of the present invention for invoking service by a server system; and

FIGS. 10 and 11 show communication sequences according to aspects of the invention.

### DESCRIPTION OF THE SPECIFIC EMBODIMENTS

A particular client/server exemplar will be presented for the purposes illustrating various aspects of the invention. However, it can be appreciated that the present invention can be embodied in as many ways as there are client/server products, including pure software products that can be downloaded to a conventional personal computer (PC) such as the Apple® line of computers running some version of its MacOS®; various Intel® processor based computers running an OS (operating system) such as Linux, or some other UNIX-based OS, or a Microsoft® OS; and other hardware and software platforms. It can be appreciated too that embodiments of the present invention can be embodied in specific hardware/software configurations; for example, in specialized client devices which have some form of data processing component and specialized hardware running software specific to the hardware.

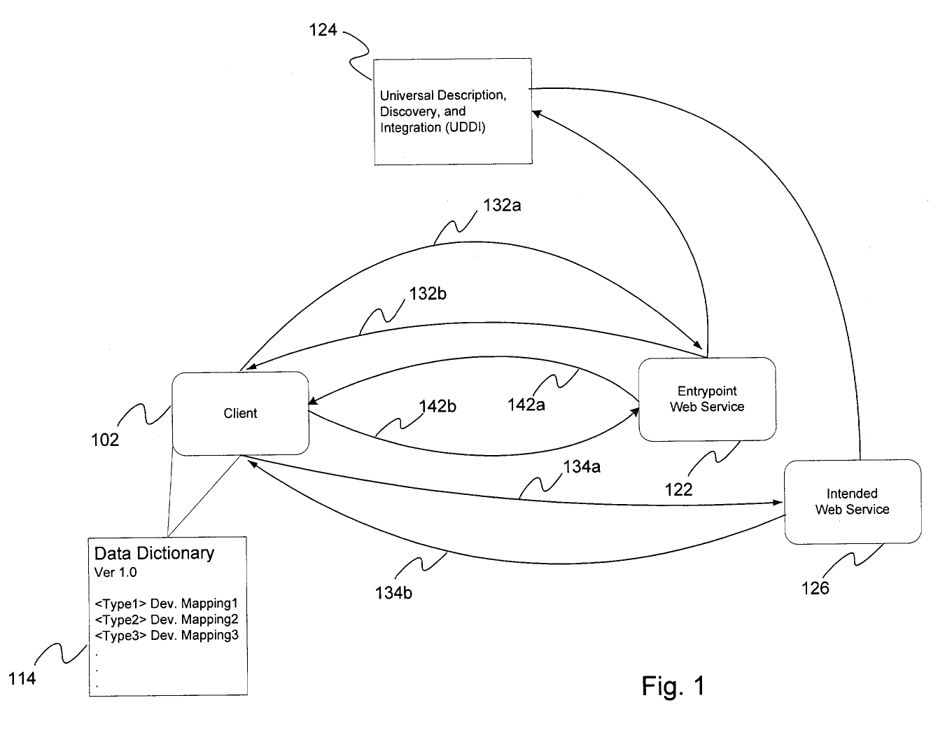

FIG. 1 illustrates an embodiment of various aspects of the present invention. A client system 102 represents a source of requests for services. The client system can be a conventional PC running network access software. For example, services can be accessed over the web via a suitable web browser provided by organizations such as Netscape, Mozilla Organization, Microsoft, and others. Suitable client-side software can be downloaded to the PC to access services. In alternative embodiments of the invention, devices such as postage meters or kiosks configured for specific applications can communicate over a communication network to programmatically access services. For example, a postage meter can be equipped with data processing capability and suitable communications functionality; e.g., modem, a LAN (local area network) connection, etc. The postage meter can be configured with special software to access a postage metering service in order to obtain additional funds for the meter.

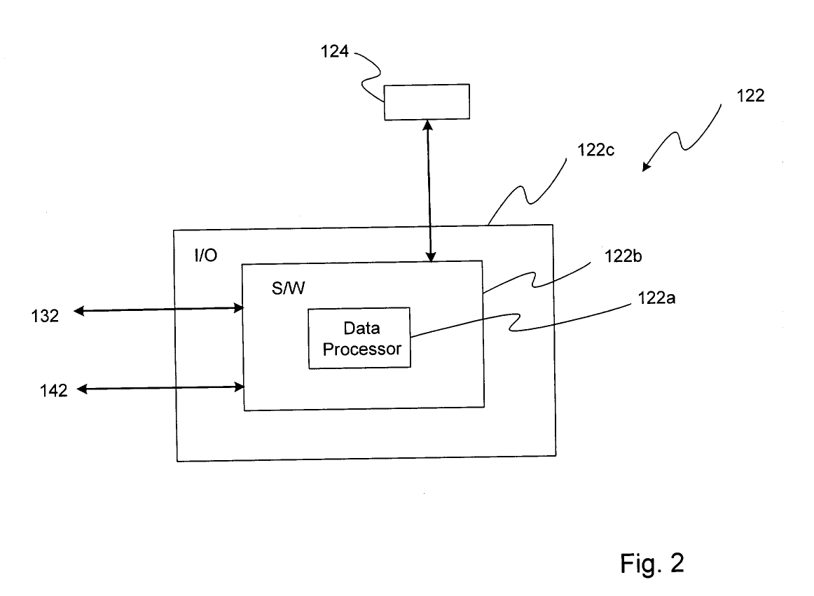

An entry point server 122 operates to provide client systems a predetermined point of access for all services. The server can be any conventional computing system configured with suitable communication interfaces and having suitable software or other access to the service(s) to be provided. For example, FIG. 2 schematically illustrates a typical server configuration. The server can include a data processing component 122a, which can be a single processor architecture, or distributed multiprocessor design. Suitable software 122b runs on the processor component, and an appropriate communication component 122c provides the I/O functionality. The communication component may include hardware such as a modem, a network interface card(s) (e.g., ethernet interface), etc. for wired or wireless communications.

The server can contain the actual software itself to provide the requested service. The server may have to access other machines in order to accomplish the tasks called for by the requested service. According to an aspect of the invention, the service can be provided by a server other than the entry point server 122.

As shown in FIG. 1, the entry point server 122 can access a location service 124 to identify a server that can provide the requested service. The figure shows an example of a service provider 126 other than the access point server 122 to illustrate the scenario whereby a service can be provided by another machine. It is noted that a particular implementation of various aspects of the present invention can be based on various specifications and protocols being developed and or being used to provide web services. For example, an implementation of the location service 124 can be based on one such specification, the Universal Description, Discovery, and Integration (UDDI) specification. This mechanism provides a registry that allows a provider to publish its services (including a programmatic interface) and clients who want to obtain services published in the registry to programmatically bind to them. Additional detail about the directory service will be discussed below. It will be appreciated from the discussion to follow that the location service 124 can be implemented using a mechanism different from the UDDI specification. It is merely a matter of convenience to use the UDDI specification to build a location service because UDDI has been defined to the point of being useful and thus obviates the need to independently develop functionally equivalent technology.

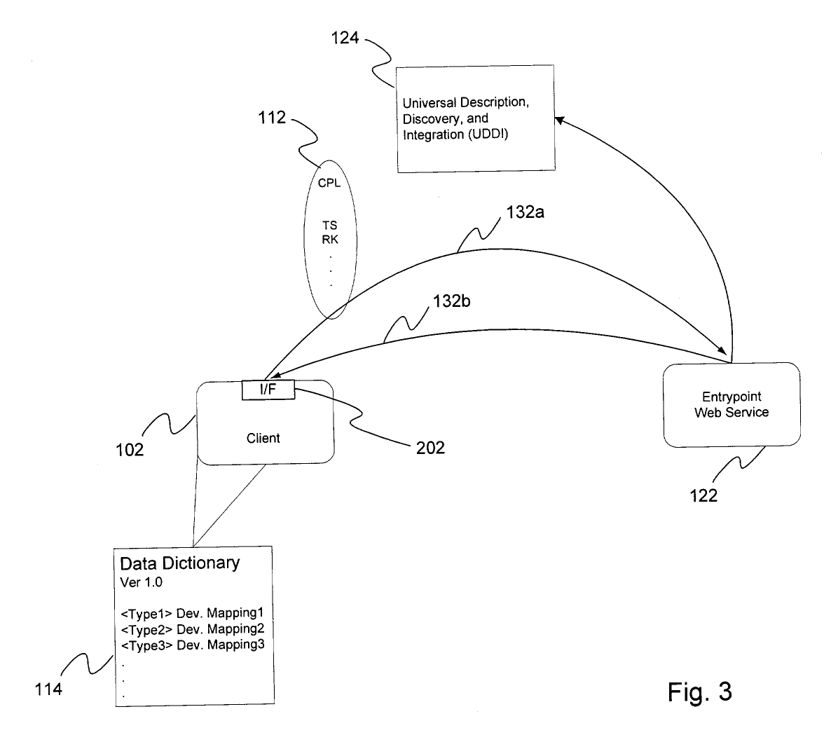

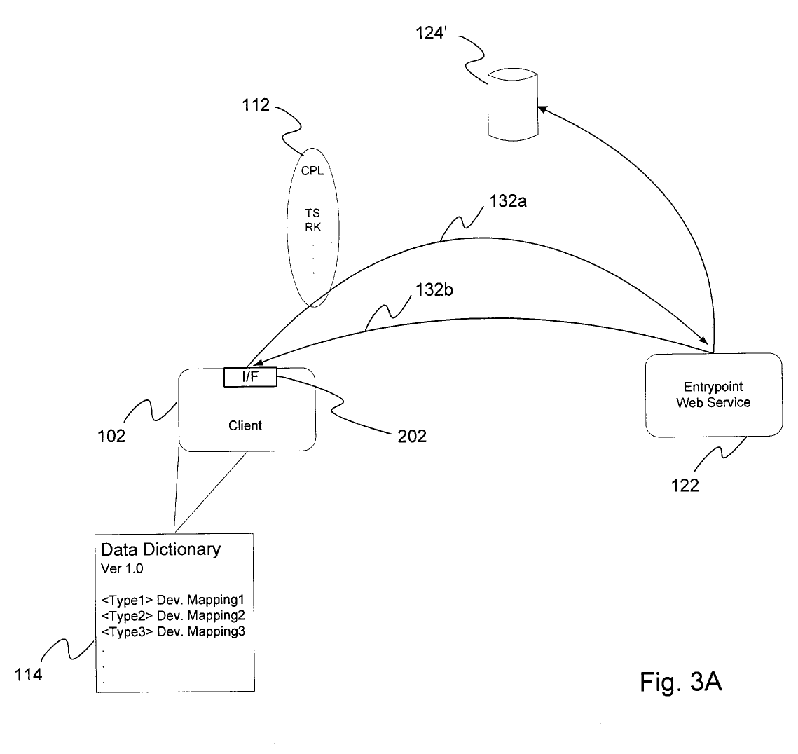

It can be appreciated of course that a UDDI compliant location service is but one of any suitably implemented service locator functionality. As can be seen in FIG. 3A, an alternative embodiment of this aspect of the invention can be a database 124′ that contains information similar to that which can be provided by the location service 124 of FIG. 1.

FIG. 1 illustrates various communication scenarios according to different aspects of the invention, each of which will be discussed further below. Generally, request and request handling can take place by the communication exchange 132a, 132b. The client system 102 communicates information 132a indicative of a requested service to the entry point server 122. In response, the entry point server can reply with a suitable response 132b. In the case where the service is provided by another machine (e.g., machine 126), an aspect of the present invention is to provide for the client to interact with that other machine. An illustrative embodiment of this aspect of the invention is illustrated in FIG. 1 by the communication exchange 134a, 134b.

In accordance with another aspect of the invention, a server can initiate an action against the client system to cause the client to perform the action. An embodiment of this aspect of the invention is shown by the communication exchange 142a, 142b between the client system 102 and the entry point server 122. The server can communicate a request 142a to the client system to initiate an action against the client. In response, the client system can perform the requested action and can reply with a suitable response 142b. Although not shown in the figure, it can be appreciated that some other system (e.g., system 126) can likewise communicate with the client system to initiate some action (i.e., service) to be performed by the client.

Another aspect of the invention is that client/server communications are self-descriptive. By self-descriptive, it is meant that services and request formats for accessing the services need not be known with particularity. For example, in accordance with the invention, a client system does not have to know in advance what machines to go to obtain services it may need. A client system does not have to have detailed knowledge in advance for requesting a service (e.g., request format, required data fields, format of data fields, etc.). As will be explained in more detail shortly, a client system according to a particular embodiment of this aspect of the invention possesses a rudimentary ability to parse a grammar in order to formulate higher level constructs for requesting services. A source of lexemes (plus perhaps semantic and syntax rules) for the grammar is represented in FIG. 1 by a data dictionary 114. As will be appreciated, this aspect of the invention enables a client system to adapt to changes in either the location of a service or the way in which the service is invoked without the need for a software upgrade or some other a priori knowledge of the changes.

According to an aspect of the invention, a client system 102 makes a request for a service. Along with that request is information representative of functional aspects of the client system. FIG. 3 shows an illustrative embodiment of this aspect of the invention. A postage metering device will be described as a specific embodiment of a client system according to the present invention to serve as a concrete example on which aspects of the invention can be better understood. The postage metering device is ubiquitous among business establishments that process paperwork. Traditionally, postage metering devices are self-contained units that occupy a volume of space somewhere in the business office. The traditional postage meter therefore can serve as an example of a client system 102 that is embodied as a specialized device.

The Internet, however, has spawned technology that has enabled the deployment of the software equivalent of a traditional postage metering device. Thus, using a PC and a suitable printer, it is possible to access postage over a communication network such as the Internet. A program can be provided on the PC to create a sufficiently secured PC environment within which postage can be obtained. Thus, for example, the Information-Based Indicia Program (IBIP) specifies a postal security device (PSD) that manages the secure postage registers of a postage meter and performs cryptographic operations for creating 2-dimensional bar codes that can be printed. All postage-related services can be handled via software that conforms to the IBIP specification such as communication with one or more Internet-based postal authority servers. Software postage metering, then, represents an example of a client system 102 that is embodied as a client in the conventional client/server networking model.

In the specific example of postage metering, the device can be configured with a suitable communication interface 202. For example, in a physical postage metering device, the communication interface 202 can be a modem connection providing a communication path to a postage server over a telephone line (POTS—plain old telephone service, DSL—digital subscriber line, etc.). The entry point server 122 would be equipped with a dial up telephone number that all such postage meters can access for service. Alternatively, it may be desirable for performance reasons to provide a different entry point server for different areas of service; e.g., a first entry point server might be provided for each state, or for each county in the state, and so on. In the case of a postage metering software client (PSD), the communication can be provided on the web over the internet. Again for performance reasons, it might be desirable to provide multiple entry point servers. Web-based entry point servers might implement a re-direct protocol so that all postage metering clients simply post a request to the one internet address and allow the entry point server to re-direct the client to another entry point server.

Any suitable set of communication protocols can be used. For example, HTTP (hypertext markup language) is used for web-based communication. As will be explained below, HTTP will be used to carry a variety of higher level protocols, including XML (extensible markup language), SOAP (simple object access language), and WSDL (web services definition language) to name a few. It will become apparent from the discussions which follow how these and other protocols can be used to implement embodiments of the various aspects of the present invention.

Continuing with FIG. 3, the client system 102 communicates RFS information to the entry point server 122. The information represents a request for a service (RFS) 132a. In an embodiment according to an aspect of the invention, the client system can include a client publish list (CPL) 112 in the RFS information. The CPL comprises information indicative of actions (services) that the client system can perform. For example, the actions in the CPL 112 that might be performed by a postage metering device (client system) might include TS (Time Sync—the metering device can accept time synchronization messages from the server with which it is communicating) and RK (ReKey—the metering device can be rekeyed (accept rekey messages) by the server with which it is communicating). The RFS information can also include information representative of the data dictionary that is stored in the client system.

The entry point server 122 responds to the request and can honor the request by performing the requested service, if the server is configured to do so. Alternatively, the server can perform a service location action to determine what entity (i.e., which server) can provide the service. The server can utilize a location service 124 to accomplish this. As noted above, the UDDI specification defines an infrastructure and method whereby service providers can publish their services in a registry that can be searched by client sites. The UDDI specification therefore represents a particular implementation of this aspect of the invention.

As noted above, a UDDI compliant location service is but one of any suitably implemented service locator functionality and other implementations of a “location service” are possible. As can be seen in FIG. 3A, an alternative embodiment of this aspect of the invention can be a database 124′ that contains information similar to that which can be provided by the location service 124 of FIG. 1. The database 124′ can be a locally accessible database, or it can be a networked configuration such as NAS (network attached storage), SAN (storage area network), or some other distributed architecture.

The result of the service location activity is a WSDL document which specifies how to programmatically access the requested web service (akin to an API—application programmer interface) from a machine 126 (e.g., server) that can provide the service. Typically, a suitable location or address information is contained in the WSDL document. The address information (e.g., an internet address) informs the client system where to send requests. For example, in the case of the web, the address information may be a universal resource locator (URL) of the intended provider 126.

The WSDL document is communicated 132b to the client system 102. For example, in the embodiment illustrated in FIG. 3, the entry point server 122 obtains the information from the location service 124 and transmits information to the client system. The entry point server can also ensure that the client system has the latest data dictionary 114 based on the data dictionary version number it received from the client system in the RFS. If necessary, the entry point server can communicate the most up to date data dictionary that can be processed by the client system. This may require the entry point server receiving information in the RFS indicative of the hardware/software capabilities of the client system and determining from that information a suitable data dictionary upgrade for that client system.

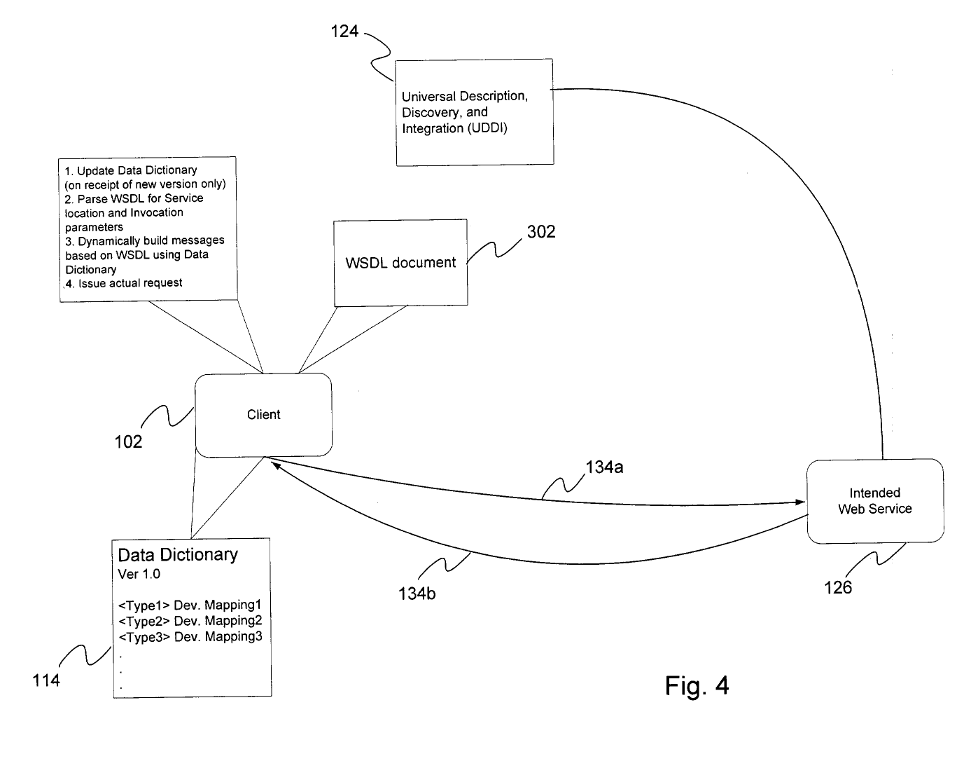

In accordance with another aspect of the invention, the client system 102 can access the service based on information received from the entry point server 122. As noted above an aspect of the invention is that the client/server communication is self-descriptive. These aspects of the invention are illustrated in the embodiment shown in FIG. 4. Here, the figure shows the location service 124 having identified a server 126 that can provide the requested service. The client has received a WSDL document 302. If a new data dictionary 114 is provided, the client system can replace its existing one with the new one.

WSDL specifies how a service is to be invoked. Thus, the client system 102 can generate an appropriate message to be sent to the intended service provider 126 by parsing through the WSDL document 302 and using the data dictionary 114 to map data from the client system's data item content to data that the intended service provider can understand. From the WSDL document, the client system can extract the location of the service and the MEP (message exchange pattern) specified by the service. The MEP describes the message(s) the service is expecting to see and the associated infrastructure data types to be sent in the message(s). Using the data dictionary, the client system can translate the associated infrastructure data types into actual data requirements and retrieve the data. The data can then be packaged into the message(s) and sent to the intended service provider 126.

Following is an example of a data dictionary which defines the data content of a client system 102. The bolded text highlights two data items that will be referenced in the SOAP message example shown below, namely, a Device_ID and a Funds_Amount. The client device or application that will use this particular data dictionary will locate its Device_ID data type by executing the information at the memory location specified as “vault”@(0, 0x04), (where vault is a known reserved area in the device). Similarly, the Funds_Amount data type is a user parameter that is passed to the device.

```
===== BEGIN Example of a Data Dictionary File =====
<?xml version = “1.0” ?>
<dd:Dictionary Device = “XL40” Version = “1.0” xmlns:dd = “http://www.mti.com/acc/dictionary.xml”>
    <dd:Entry>
        <dd:DataType> AscReg </dd:DataType>
        <dd:Definition> vault@(1, 0x00) </dd:Definition>
    </dd:Entry>
    <dd:Entry>
        <dd:DataType> DscReg </dd:DataType>
        <dd:Definition> vault@(1, 0x04) </dd:Definition>
    </dd:Entry>
    <dd:Entry>
        <dd:DataType> ControlTotal </dd:DataType>
        <dd:Definition> Sum(AscReg, DscReg) </dd:Definition>
    </dd:Entry>
    <dd:Entry>
        <dd:DataType> Device_ID </dd:DataType>
        <dd:Definition> vault@(0, 0x04) </dd:Definition>
    </dd:Entry>
    <dd:Entry>
        <dd:DataType> Funds_Amount </dd:DataType>
        <dd:Definition> UserParam 1 </dd:Definition>
    </dd:Entry>
</dd:Dictionary>
===== Example of a Data Dictionary File END =====
```

Following is an example of a message exchange pattern (MEP) for a request for service (RFS). The MEP message would be encapsulated in a SOAP message for transport. The SOAP message might itself be encapsulated in further messages (e.g., ethernet packet, HTTP), depending on the communication protocol.

```
=====BEGIN Example of a Request For Service (RFS), MEP only =====
<?xml version = “1.0” ?>
<mep:RFS Device = “XL40” xmlns:mep = “http://www.mti.com/acc/
mep”>
    <mep:Device_ID> 0401007234 </mep:Device_ID>
    <mep:AuthCert> 13 00 32 33 91 A3 38 FF 2F CA 99
    </mep:AuthCert>
    <mep:Service> FR </mep:Service>
    <mep:Dictionary> 1.0 </mep:Dictionary>
    <mep:Chirp>
        <mep:Service> TS </mep:Service>
        <mep:Service> RK </mep:Service>
    </mep:Chirp>
</mep:RFS>
===== Example of a Request For Service (RFS), MEP only END =====
```

Following is an example of the contents of a WSDL document which defines the message formats that the a client device or application will use to request and accept a response for a Reset Postal Funds operation. Some fields have been bolded to highlight aspects of the WSDL information. For example, the targetNamespace field specifies address information (e.g., a URL) for communicating with the provider 126 which can provide the requested service. The element ResetPostalFunds identifies a template that the client system 102 parses to generate the request that is then communicated to the service provider 126. The element ResetPostalFundsResponse identifies a template that defines the structure of the response that is expected from the provider 126.

```
===== BEGIN Reset Postal Funds SOAP Format WSDL definition =====
<?xml version=“1.0” encoding=“utf-8”?>
<definitions xmlns:http=“http://schemas.xmlsoap.org/wsdl/http/”
xmlns:soap=“http://schemas.xmlsoap.org/wsdl/soap/”
xmlns:s=“http://www.w3.org/2001/XMLSchema”
xmlns:s0=“http://www.NeopostMTI.com/Postal/services”
xmlns:soapenc=“http://schemas.xmlsoap.org/soap/encoding/”
xmlns:tm=“http://microsoft.com/wsdl/mime/textMatching/”
xmlns:mime=“http://schemas.xmlsoap.org/wsdl/mime/”
targetNamespace=“http://www.NeopostMTI.com/Postal/services”
xmlns=“http://schemas.xmlsoap.org/wsdl/”>
  <types>
  <s:schema elementFormDefault=“qualified”
              targetNamespace=“http://www.NeopostMTI.com/Postal/services”>
    <s:element name=“ResetPostalFunds”>
      <s:complexType>
        <s:sequence>
          <s:element minOccurs=“1” maxOccurs=“1” name=“Device_ID” type=“s:int” />
          <s:element minOccurs=“1” maxOccurs=“1” name=“Funds_Amount” type=“s:double” />
        </s:sequence>
      </s:complexType>
    </s:element>
    <s:element name=“ResetPostalFundsResponse”>
      <s:complexType>
        <s:sequence>
          <s:element minOccurs=“1” maxOccurs=“1” name=“ResetPostalFundsResult” type=“s:double” />
        </s:sequence>
      </s:complexType>
    </s:element>
    <s:element name=“MTIPostalHeader” type=“s0:MTIPostalHeader” />
    <s:complexType name=“MTIPostalHeader”>
      <s:sequence>
        <s:element minOccurs=“0” maxOccurs=“1” name=“Username” type=“s:string” />
        <s:element minOccurs=“0” maxOccurs=“1” name=“Password” type=“s:string” />
        <s:element minOccurs=“1” maxOccurs=“1” name=“Created” type=“s:dateTime” />
        <s:element minOccurs=“1” maxOccurs=“1” name=“Expires” type=“s:long” />
      </s:sequence>
    </s:complexType>
    </s:schema>
  </types>
  <message name=“ResetPostalFundsSoapIn”>
    <part name=“parameters” element=“s0:ResetPostalFunds” />
  </message>
  <message name=“ResetPostalFundsSoapOut”>
    <part name=“parameters” element=“s0:ResetPostalFundsResponse” />
  </message>
  <message name=“ResetPostalFundsMTIPostalHeader”>
    <part name=“MTIPostalHeader” element=“s0:MTIPostalHeader” />
  </message>
  <portType name=“Reset_x0020_Operations_x0020_Web_x0020_ServiceSoap”>
    <operation name=“ResetPostalFunds”>
      <documentation>This method resets postal funds for the requesting device. It is part of the Neopost
                    MTI Postal suite of WEB Services and it can accept an Neopost Postal
                    Header.</documentation>
      <input message=“s0:ResetPostalFundsSoapIn” />
      <output message=“s0:ResetPostalFundsSoapOut” />
    </operation>
  </portType>
  <binding name=“Reset_x0020_Operations_x0020_Web_x0020_ServiceSoap”
              type=“s0:Reset_x0020_Operations_x0020_Web_x0020_ServiceSoap”>
    <soap:binding transport=“http://schemas.xmlsoap.org/soap/http” style=“document” />
    <operation name=“ResetPostalFunds”>
      <soap:operation soapAction=“http://www.NeopostMTI.com/Postal/services/ResetPostalFunds”
                style=“document” />
      <input>
        <soap:body use=“literal” />
        <soap:header message=“s0:ResetPostalFundsMTIPostalHeader”
                part=“MTIPostalHeader”
                use=“literal” />
      </input>
      <output>
        <soap:body use=“literal” />
        <soap:header message=“s0:ResetPostalFundsMTIPostalHeader”
                part=“MTIPostalHeader”
                use=“literal” />
      </output>
    </operation>
  </binding>
  <service name=“Reset_x0020_Operations_x0020_Web_x0020_Service”>
    <documentation>A service that provides the Neopost Mail Systems Resetting Postal Funds
                  Operations.</documentation>
    <port name=“Reset_x0020_Operations_x0020_Web_x0020_ServiceSoap”
          binding=“s0:Reset_x0020_Operations_x0020_Web_x0020_ServiceSoap”>
      <soap:address
          location=“http://localhost/MTIPostal_SVC/mailsysresetservice/resetpostalfunds.asmx” />
    </port>
  </service>
</definitions>
===== Reset Postal Funds SOAP Format WSDL definition END =====
```

Following is a SOAP formatted message that a client system 102 can send to the intended service provider 126. The specific example shown is for postage metering devices. The service that is sought by the client system is a reset of postal funds for the metering device. The entry point server 122 can be a postal authority server. A physical postage metering client device can dial up the service and transmit the SOAP message as shown, directly to the server. A software-based postage metering client can access the postal authority server over the Internet, in which case the SOAP message may be encapsulated in an HTTP (hypertext transport protocol) message. The highlighted portions shown below include a device id that allows the server to debit the appropriate account for the funds and a fund amount. This information can be used by the postal authority server to locate a suitable server to perform the requested service, which is the resetting of funds in the postage meter client.

```
===== BEGIN SOAP formatted Reset Postal Funds Request =====
<?xml version=“1.0” encoding=“utf-8”?>
<soap:Envelope xmlns:xsi=http://www.w3.org/2001/XMLSchema-instance
xmlns:xsd=“http://www.w3.org/2001/XMLSchema
xmlns:soap=“http://schemas.xmlsoap.org/soap/envelope/”>
    <soap:Header>
        <MTIPostalHeader xmlns= “http://www.NeopostMTI.com/
        Postal/services/”>
            <Username>KenD</Username>
            <Password>KpwdKenD</Password>
            <Created>01/29/03 12:00:00.0</Created>
            <Expires>8000</Expires>
        </MTIPostalHeader>
    </soap:Header>
    <soap:Body>
        <ResetPostalFunds xmlns= “http://www.NeopostMTI.com/
        Postal/services/”>
            <Device_ID>0401007234</Device_ID>
            <Funds_Amount>150.00</Funds_Amount>
        </ResetPostalFunds>
    </soap:Body>
</soap:Envelope>
===== SOAP formatted Reset Postal Funds Request END =====
```

To complete the example, a response from the postal authority server (entry point server 122) might comprise the SOAP message shown below. The highlighted value 150.00 signifies to the client system 102 that it can update its local data with the request reset amount.

```
=====BEGIN SOAP formatted Response to the Postal Funds Request =====
<?xml version=“1.0” encoding=“utf-8”?>
<soap:Envelope xmlns:xsi=http://www.w3.org/2001/XMLSchema-instance
xmlns:xsd=“http://www.w3.org/2001/XMLSchema
xmlns:soap=“http://schemas.xmlsoap.org/soap/envelope/”>
    <soap:Body>
        <ResetPostalFundsResponse xmlns= “http://www.NeopostMTI.com/Postal/services/”>
            <ResetPostalFundsResult>150.00</ResetPostalFundsResult>
        </ResetPostalFundsResponse>
    </soap:Body>
</soap:Envelope>
===== SOAP formatted Response to the Postal Funds Request END =====
```

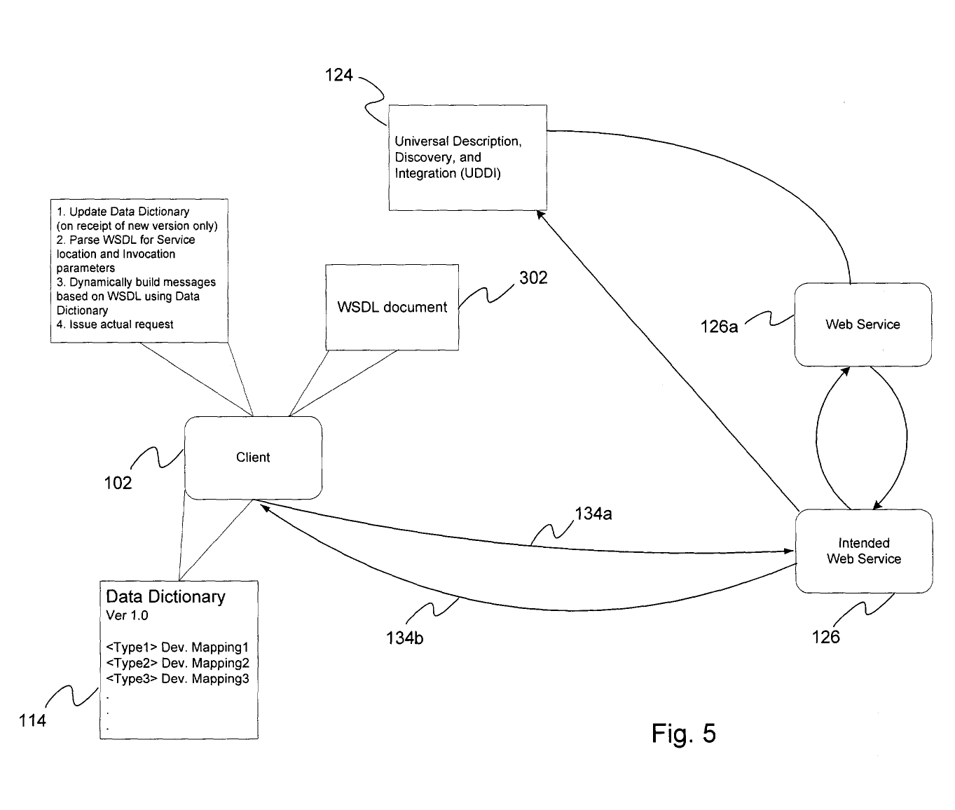

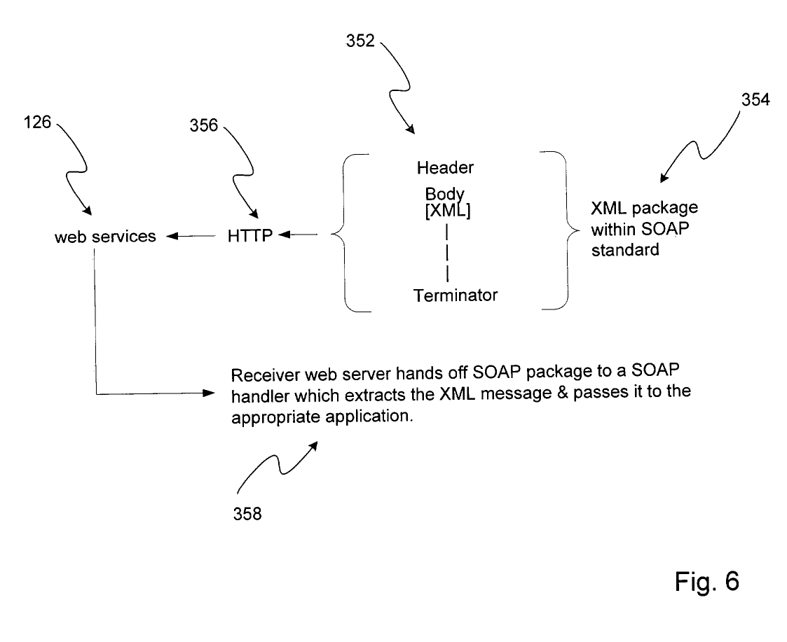

FIGS. 5 and 6 illustrate subsequent processing that can take place at the intended service provider 126. As shown in FIG. 6, standard network communications methodologies can be used. For example, service requests can be specified with the extensible markup language (XML) standard 352 and packaged for transmission using the simple object access protocol (SOAP) 354. XML is a meta-language that can specify interactions between the client and the server to perform a service. The SOAP message can be transmitted via standard hypertext transfer protocol (HTTP) 356 to the intended service provider 126. There, the provider can hand-off the SOAP package to a SOAP handler, which in turn extracts the XML. The XML messages in turn can then be converted to support applications (middleware) to perform the task(s) corresponding to the requested service 358. Results that may be produced can be encapsulated in appropriate XML and SOAP messages and sent back to the client system.

FIG. 5 further illustrates that the intended service provider 126 may require services of other machines in order to perform the requested service. The location service 124 (or some other server providing similar services based on something other than the UDDI specification) can be used by the service provider 126 to locate services it may need, but which are not locally available. The example illustrated in FIG. 5 shows that the location service has identified an auxiliary service provider 126a on behalf of the intended service provider 126. The provider 126 can then communicate with the auxiliary service provider to access service(s) it may need to perform the requested service. It is understood of course that still other service providers may need to be called on in order for the server 126 to complete its processing on behalf of the client system 102.

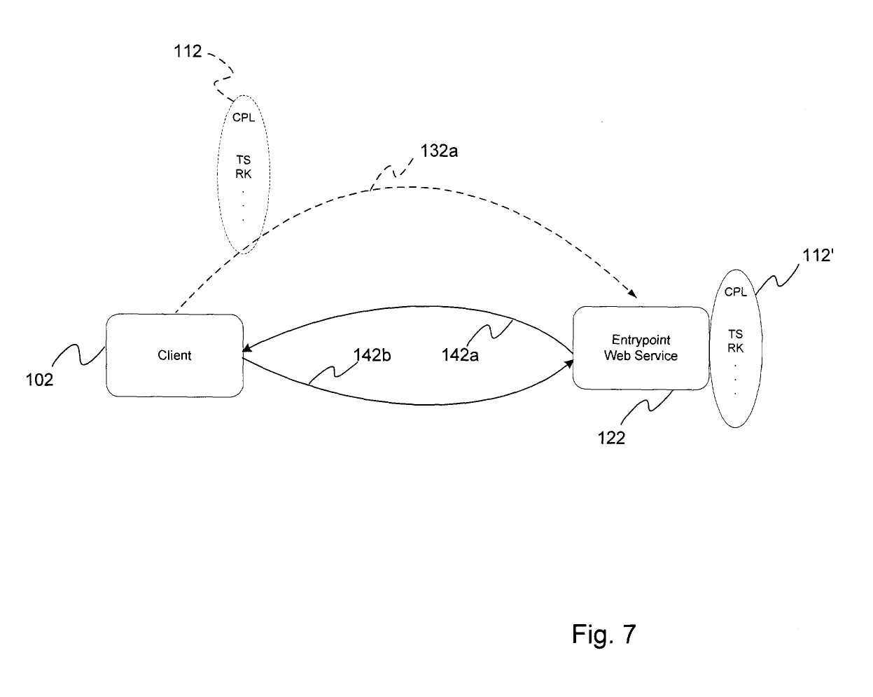

Still another aspect of the present invention is providing for a server that can discover “services” from client systems. FIG. 7 illustrates an embodiment of this aspect of the invention where a server site can initiate services against a client system; i.e., services that the client system performs on behalf of the server site. Recall from FIG. 3 that the initial request message from the client system 102 to the entry point server 122 included a client publish list (CPL) 112. The CPL contains a suitably encoded list of activities (services) that the client system can perform. The CPL contains a suitably encoded list of activities (services) that the client system can perform, of which the server can request the WSDL information on how to perform the activities. Thus, the entry point server 122 can access it's local copy of the CPL 112′ to generate a suitable message(s), much in the way that the client system can generate a message(s) to be sent to the intended service provider 126. The entry point server then communicates 142a the message(s) to the client system to initiate the requested activity to be performed by the client system.

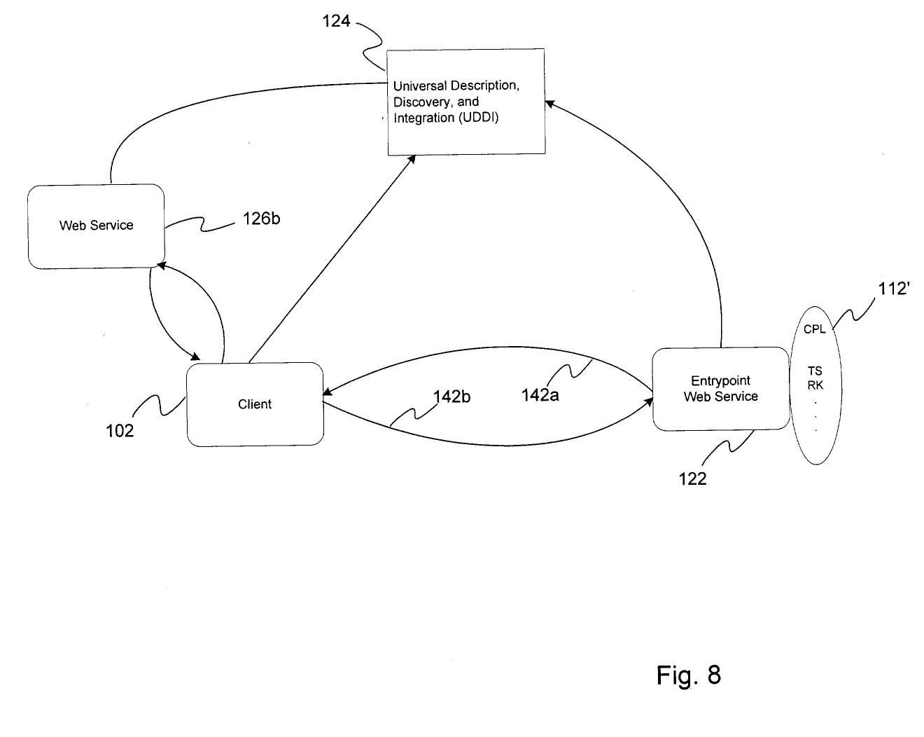

FIG. 8 illustrates a possible scenario in which the client system 102, during the course of performing a requested activity, can seek services available at other provider sites. This can be accomplished by querying a location service such as the server 124 in order to locate the needed service. Suppose the query results in the location service (e.g., server 124) providing information indicating that the requested service can be accessed a service provider 126b. The client system can generate suitable request for service to be communicated to the provider 126b. Though not shown, it is possible that the client system can turn around and send a message to the entry point server 122 to obtain a service that is needed by the client system.

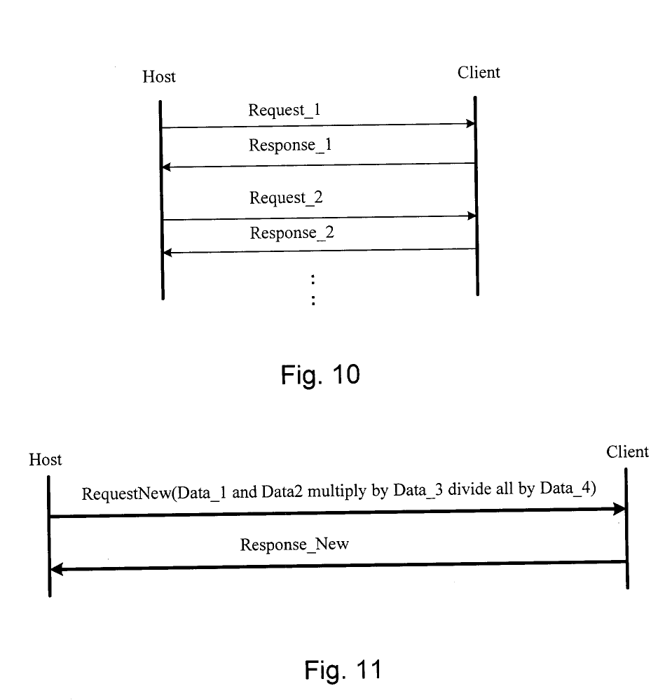

FIG. 10 shows a communication sequence between client and server according to this aspect of the invention according to the embodiment of the invention in FIG. 8. Suppose data content of the client system 102 comprises: data_1, data_2, data_3, . . . data_n. Some of the data may be a function of the other data. A request that can be issued against the client system 102 might be to provide some of that data. As shown in FIG. 10, a request (Request_1) is issued to the client system, for example, to return some of its data. A response (Response_1) to the server may include the requested data. Another request (Request_2) can be issued against the client, and a response (Response_2) might be returned to the server.

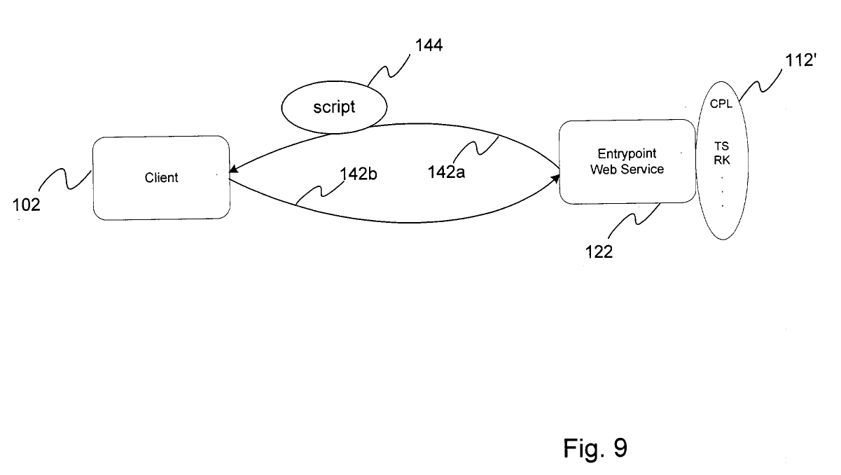

FIG. 9 illustrates an embodiment of still another aspect of the present invention, new services can be defined and new responses can be provided. The entry point server can generate a script 144 and transmit (download) that script to the client system, where it is then “executed” by the client system. The “script” can be any suitable format that the client system can recognize. The script can be an interpreted language; e.g., Java code, Basic program, etc., so that the client system “executes” the script by interpreting it with an appropriate interpreter to thereby perform a series of actions according to the script. The script can be executable code (e.g., compiled and/or assembled code) wherein the client system “executes” the code by loading it in memory and transferring control of the data processing component to the code.

Recall that the entry point server 122 has knowledge of the data item content of the client system by way of the data dictionary 114. The server can therefore generate a script that is particular to the client system's data content. In this way, the server can dynamically define new actions to be performed by the client system which fully utilize the data capability and processing capability of the particular client system. For example, the script might direct the client system to calculate averages of certain data that it contains which have accumulated over time. The communication sequence shown in FIG. 11 illustrates a generalized example of a script being downloaded to the client system. A new request is defined and a new response is produced. The script that is downloaded can be transient; i.e., used once or for a limited period of time. The script can serve to define or redefine new functionality for the client system on a longer term basis.

What is claimed is:

1. A computer-implemented method for invoking a service comprising:
conveying first information from a client device to a server device, said first information indicative of a requested service;
obtaining, at said server device, service-related information based at least on said requested service, said service-related information including address information for communicating with a provider;
conveying said service-related information from said server device to said client device;
generating, at said client device, second information based on said service-related information, said second information representative of a request for said requested service; and
conveying said second information from said client device to said provider using said address information,
wherein said requested service can be invoked.

2. The method of claim 1 further including conveying dictionary information from said server device to said client device, said dictionary information representative of a data dictionary, said step of generating second information further being based on information contained in said data dictionary.

3. The method of claim 2 wherein said client server contains a first data dictionary, wherein said step of conveying dictionary information is based on revision information associated with said first data dictionary.

4. The method of claim 1 wherein said first information is further indicative of one or more actions that can be performed by said client device.

5. The method of claim 4 further comprising conveying third information from said server device to said client device, said third information representative of an action to be invoked, said action being performed by said client device.

6. The method of claim 1 further comprising conveying third information from said server device to said client device, said third information comprising a script, said method further including executing said script by said client device.

7. The method of claim 6 wherein said script is an executable program.

8. The method of claim 6 wherein said step of executing includes interpreting said script.

9. The method of claim 1 where said service-related information comprises a Web Services Definition Language (WSDL) specification.

10. The method of claim 1 wherein said obtaining service-related information comprises conveying information between said service device and a locator service.

11. The method of claim 10 wherein said information conveyed between said service device and said locator service is based on the Universal Discovery, Description, and Integration (UDDI) specification.

12. The method of claim 10 wherein said location service is a database.

13. The method of claim 1 wherein said obtaining service-related information comprises:
determining if said server device can perform said requested service;
if said server device can perform said requested service, then generating said service-related information, said service-related information suitable for said client system to generate a suitable request for service; and
if said server device cannot perform said requested service, then accessing a locator service and obtaining from said locator service said service-related information.

14. A method for invoking a service comprising:
receiving at a first server system information from a client system indicative of a requested service and information from said client system indicative of one or more actions that said client system can perform;
obtaining service-related information, said service-related information having content which allows said client system to generate a request for service (RFS) to invoke said requested service and address information which allows said client system to send said RFS to a destination, said content comprising information for requesting a service from a second server system and said address information is representative of an address of said second server system; and
communicating said service-related information to said client system,
wherein said first server system can invoke one of said one or more actions on said client system.

15. The method of claim 14 further including communicating to said client system information indicative of a request to perform one of said one or more actions.

16. The method of claim 14 further comprising receiving at said first server system dictionary information from said client system, said dictionary information indicative of a data dictionary, said data dictionary representative of a data content of said client system.

17. The method of claim 16 further comprising communicating information to said client system representative of an updated data dictionary based on said dictionary information.

18. The method of claim 17 wherein said dictionary information represents a version of said data dictionary.

19. The method of claim 14 further comprising generating a script and communicating said script to said client system, said script being executable by said client system to perform an action that is not one of said one or more actions that said client system can perform.

20. The method of claim 19 wherein said script is based on a data dictionary that is indicative of a data content of said client system.

21. The method of claim 19 wherein said script is interpreted.

22. The method of claim 19 wherein said script is executable code.

23. The method of claim 14 wherein said step of obtaining service-related information includes communicating with a location service.

24. The method of claim 23 wherein said communicating with a location service is performed in accordance with the UDDI specification.

25. The method of claim 23 wherein said location service is a database.

26. A data processing system comprising:
a data processing component;
a communication component operative with said data processing component to provide data communication capability; and
computer program code, said computer program code configured to operate said data processing component to perform steps of:
determining receipt of client information comprising information indicative of a requested service and information representative of a data dictionary, said client information being received from a client system;
obtaining service-related information based on said requested service, said service-related information comprising first information used to generate a request for said requested service and second information used to send said request to a service provider;
producing response information to be sent to said client system, including determining whether to add information representative of an updated data dictionary to said response information based on said data dictionary, said response information also comprising said service-related information; and
communicating said response information to said client system.

27. The system of claim 26 wherein said client information further comprises information representative of one or more actions that said client system can perform, said computer program code further configured to operate said data processing component to perform steps of sending, to said client system, information indicative of at least one of said one or more actions, wherein said client system performs said at least one action in response thereto.

28. The system of claim 26 wherein said computer program code is further configured to operate said data processing component to perform steps of generating a script and communicating said script to said client system, said script being executable by said client system.

29. The system of claim 28 wherein said script is based on data content of said data dictionary.

30. The system of claim 28 wherein said script is interpreted.

31. The system of claim 28 wherein said script is executable code.

32. The system of claim 26 wherein, in order to perform said step of obtaining service-related information, said computer program code is further configured to operate said data processing component to perform a step of communicating with a location service in accordance with the UDDI specification.

33. The system of claim 26 wherein, in order to perform said step of obtaining service-related information, said computer program code is further configured to operate said data processing component to perform steps of accessing database information from a database, said service-related information being based on said database information.

34. The system of claim 26 wherein said information representative of a data dictionary is a version number of said data dictionary.

35. A method for programmatically accessing services comprising:
communicating, from a client system, first information to a first server, said first information comprising information indicative of a request for a service and information indicative of one or more actions that can be invoked against said client system;
receiving at said client system second information;
generating third information based on content of said second information; and
communicating, from said client system, said third information to a second server system, an address of said second server system being represented in said second message,
wherein said service can be invoked in said second server system.

36. The method of claim 35 further comprising receiving at said client system fourth information, said fouth information indicative of one of said one or more actions that can be invoked against said client system, and performing said one of said actions.

37. The method of claim 36 wherein if an additional service is required to perform said one of said actions, then communicating with a locator service to obtain service-related information for said additional service.

38. The method of claim 37 wherein said step of communicating with a locator service is performed according to the UDDI specification.

39. The method of claim 37 wherein said locator service is a database.

40. The method of claim 35 further comprising receiving at said client system fourth information, said fouth information comprising a script to be executed by said client system, wherein execution of said script causes said client system to perform an action other than said one or more actions that can be invoked against said client system.

41. The method of claim 40 wherein said script is executable program code.

42. The method of claim 40 further including interpreting said script.

43. The method of claim 35 wherein said step of generating third information is based on content of a data dictionary.

44. The method of claim 35 wherein said one or more second messages includes a data dictionary.

45. The method of claim 44 wherein said step of generating third information is based on content of said data dictionary.

46. The method of claim 35 wherein said second message comprises a WSDL document.

47. The method of claim 46 wherein said step of generating third information is based on said WSDL.

48. A data processing system having computer program code configured to operate said data processing system, said computer program code effective to cause said data processing system to invoke a service by performing steps comprising:
communicating first information to a first server, said first information comprising information indicative of a service and information indicative of one or more actions that can be performed said data processing system;
receiving from said first server system second information;
generating third information based on content of said second information and further based on content of a data dictionary accessible by said data processing system; and
communicating said third information to a second server system, an address of said second server system being represented in said second message,
wherein said service can be invoked in said second server system.

49. The system of claim 48 wherein said program code is further effective to cause said data processing system to include version information associated with said data dictionary into said first information.

50. The system of claim 49 wherein said program code is further effective to cause said data processing system to receive an updated data dictionary and replace said data dictionary with said updated data dictionary so that said step of generating third information is based on content of said updated data dictionary.

51. The system of claim 48 wherein said program code is further effective to cause said data processing system to receive a script and to execute said script, thereby performing an action that is exclusive of said one or more actions that can be performed by said data processing system.

52. The system of claim 48 wherein said second information comprises a WSDL document, said step said third information comprising a request for said service to be performed by said second server, wherein said program code is further effective to cause said data processing system to generate said request based on said WSDL document.

53. A system for invoking services comprising:
means for receiving at a first server system information from a client system indicative of a requested service and information from said client system indicative of one or more actions that said client system can perform;
means for obtaining service-related information, said service-related information having content which allows said client system to generate a request for service (RFS) to invoke said requested service and address information which allows said client system to send said RFS to a destination, said content comprising information for requesting a service from a second server system and said address information is representative of an address of said second server system; and
means for communicating said service-related information to said client system,
wherein said first server system can invoke one of said one or more actions on said client system.

54. The system of claim 53 further comprising means for communicating to said client system information indicative of a request to perform one of said one or more actions at said client system.

55. The system of claim 53 further comprising means for generating a script and for communicating said script to said client system, said script being executable by said client system to perform an action that is not one of said one or more actions that said client system can perform.

56. A system for invoking services comprising:
means for communicating, from a client system, first information to a first server, said first information comprising information indicative of a request for a service and information indicative of one or more actions that can be invoked against said client system;
means for receiving at said client system second information;
means for generating third information based on content of said second information; and
means for communicating, from said client system, said third information to a second server system, an address of said second server system being represented in said second message, wherein said service can be invoked in said second server system.

57. The system of claim 56 further comprising menas for receiving at said client system fourth information, said fouth information indicative of one of said one or more actions that can be invoked against said client system, and performing said one of said actions.

58. The system of claim 56 further comprising means for receiving at said client system fourth information, said fouth information comprising a script to be executed by said client system, wherein execution of said script causes said client system to perform an action other than said one or more actions that can be invoked against said client system.
